(19) United States
(12) Patent Application Publication
(10) Pub. No.: US 2022/0010246 A1
(43) Pub. Date: Jan. 13, 2022

(54) IMPROVED BEER

(71) Applicant: FOOD FOR FUTURE S.R.L. SOCIETÁ BENEFIT, Milano (IT)

(72) Inventor: Guglielmo BUONAMICI, SAN GIULIANO TERME (Pisa) (IT)

(21) Appl. No.: 17/291,368

(22) PCT Filed: Oct. 31, 2019
(86) PCT No.: PCT/IB2019/059334

§ 371 Date: May 5, 2021

(30) Foreign Application Priority Data
Nov. 6, 2018 (IT) 102018000010072

(51) Int. Cl. C12C 5/02; C12C 11/00

(52) U.S. Cl. CPC C12C 5/02; C12C 11/00

(57) ABSTRACT

A beer including Momordica cochinchinensis extracts including lycopene and Arachis hypogaea extracts including coenzyme Q10 is provided.

This invention concerns a beer of the type specified in the preamble of the first claim.

As is well known, beer is one of the most widespread and oldest alcoholic beverages in the world.

It is produced via alcoholic fermentation, with strains of Saccharomyces cerevisiae or Saccharomyces carlsbergensis, of sugars deriving from starchy sources, the most commonly used of which is malted barley, or germinated and dried barley, often simply called malt.

Wheat, maize, rice, and, to a lesser extent, oats, spelt, and rye may be used in its production. Other, less commonly used plants include: manioc root, millet, and sorghum in Africa, potato in Brazil, and agave in Mexico.

To produce beer, the malt is immersed in hot water where the starches present are converted into fermentable sugars, thanks to the action of some enzymes present in the rootlet that forms during germination. This sugary must can be flavoured with herbs, fruit, or, more commonly, hops. Subsequently, a yeast is used, which begins the fermentation and leads to the formation of alcohol, together with carbon dioxide, which is mostly expelled, and other waste products that derive from the anaerobic respiration of the yeasts.

The prior art described comprises some significant drawbacks.

In particular, beer, being a beverage that is often drunk and, at the same time, one that is full of sugars and other ingredients that are dangerous for human health, can, therefore, be the cause of major health problems.

In this situation the technical task of this invention is to devise a beer able to substantially overcome at least some of the drawbacks mentioned.

Within the scope of said technical task an important purpose of the invention is to obtain a beer with particular, beneficial effects for the human body.

The technical task and specified purposes are achieved by a beer as claimed in the appended claim 1. Examples of preferred embodiments are described in the dependent claims.

In this document, the measures, values, shapes, and geometric references (such as perpendicularity and parallelism), when associated with words like “about” or other similar terms such as “approximately” or “essentially”, are to be understood as except for measurement errors or inaccuracies owing to production and/or manufacturing errors and, above all, except for a slight divergence from the value, measure, shape, or geometric reference with which it is associated. For example, these terms, if associated with a value, preferably indicate a divergence of not more than 10% of the value.

The measurements and data provided herein are to be considered as performed in ICAO International Standard Atmosphere (ISO 2533), unless otherwise specified. The beer may comprise resveratrol.

In particular, the beer may comprise Polygonum Cuspidatum extracts comprising resveratrol. Alternatively, or in addition, it may comprise Vitis vinifera extracts (usefully, Vitis Vinifera branches) comprising resveratrol.

Polygonum Cuspidatum extracts can be obtained through a drying and titration process of the powders or by solvent extraction.

The Vitis vinifera extracts can be obtained by Soxhlet reflux extraction, with ultrasound or supercritical gas, and the addition of sulphur dioxide as the solvent. These extracts are preferably obtained using the Soxhlet reflux method with methanol. This method involves the fermentation and hydrolysis of Vitis vinifera grapes with the addition of yeast, usefully Saccharomycetaceae (such as Saccharomyces cerevisiae) and preferably operating at pH 7 for about 4 days; evaporation and centrifugation to remove the solvent from the solution obtained above; Soxhlet extraction; methanol removal by boiling-point heating, and extraction thereof by evaporation.

The beer may comprise resveratrol and/or pterostilbene.

In particular, the beer may comprise Polygonum Cuspidatum extracts comprising resveratrol and/or pterostilbene. Alternatively, or in addition, the beer may comprise Vitis vinifera extracts (usefully, Vitis Vinifera branches) comprising resveratrol and/or pterostilbene.

The beer may preferably comprise Polygonum Cuspidatum extracts comprising resveratrol and/or pterostilbene and/or Vitis vinifera extracts comprising resveratrol and pterostilbene. More preferably, it comprises Polygonum Cuspidatum extracts comprising resveratrol and/or pterostilbene and Vitis vinifera extracts comprising resveratrol and/or pterostilbene.

The content of Polygonum Cuspidatum extracts essentially ranges from 1 g/l to 20 g/l, more specifically from 3 g/l to 15 g/l, and preferably from 5 g/l to 10 g/l.

The content of the Polygonum Cuspidatum extracts, as well as the extracts described in this document, is calculated based on the volume of beer and preferably of the fermentation must.

The content of the Vitis vinifera extracts essentially ranges from 1 g/l to 20 g/l, more specifically from 3 g/l to 15 g/l, and preferably from 5 g/l to 10 g/l.

Usefully, the content of Polygonum Cuspidatum and Vitis vinifera extracts essentially ranges from 1 g/l to 20 g/l, more specifically from 3 g/l to 15 g/l, and preferably from 5 g/l to 10 g/l. Said extracts may be in equal proportions.

The beer may comprise trimethylglycine.

The beer may comprise Beta vulgaris L. (hereinafter referred to as Beta vulgaris) extracts comprising trimethylglycine.

The content of trimethylglycine and, in particular, Beta vulgaris extracts is at least equal to, essentially, 100%, more specifically to 250%, and even more specifically to 1000% of the content of resveratrol and, in particular, of said extracts (preferably Polygonum cuspidatum) comprising resveratrol.

Usefully, the content of Beta vulgaris extracts essentially ranges from 1 g/l to 20 g/l, more specifically from 3 g/l to 15 g/l, and preferably from 5 g/l to 10 g/l.

Alternatively or in addition, the methylation process comprises Chenopodium quinoa extracts comprising trimethylglycine.

The methylation process preferably comprises Beta vulgaris extracts comprising trimethylglycine and Chenopodium quinoa extracts comprising trimethylglycine.

The content of trimethylglycine and, in particular, Chenopodium quinoa extracts is lower than that of the Beta vulgaris extracts. More specifically, it is significantly less than 50%, even more specifically 10% of the content of Beta vulgaris extracts. The content of Chenopodium quinoa extracts essentially ranges from 15% to 5% of the content of Beta vulgaris extracts.

The beer may comprise lycopene and, in particular, Momordica cochinchinensis extracts comprising lycopene.

The beer may comprise essential fatty acids and, to be specific, Momordica cochinchinensis extracts comprising essential fatty acids.

The beer may preferably comprise Momordica cochinchinensis extracts comprising lycopene and essential fatty acids.

The content of Momordica cochinchinensis extracts is significantly less than 10 g/l and, more precisely, essentially ranges from 1 g/l to 7 g/l, preferably from 2 g/l to 5 g/l. Said content is essentially equal to half of the total content of Polygonum Cuspidatum and Vitis vinifera extracts.

The beer may comprise coenzyme Q10, also called ubiquinone or vitamin Q, and, more specifically, Arachis hypogaea extracts comprising coenzyme Q10.

The content of Arachis hypogaea extracts is essentially lower than 10 g/l and, more specifically, ranges from 1 g/l to 6 g/l, preferably from 2 g/l to 4 g/l.

Arachis hypogaea extracts can be obtained by a drying and titration process of the powders or by solvent extraction.

The beer may comprise coumarins and, to be precise, Medicago sativa extracts comprising coumarins.

The beer may comprise folic acid (Vitamin B9) and, in particular, Medicago sativa extracts comprising folic acid.

To be precise, said Medicago sativa extracts may comprise coumarins, folic acid, and one or more (preferably all) of the following: triterpenoid saponins, isoflavones, and policosanols.

The content of Medicago sativa extracts is significantly lower than 12 g/l and, more specifically, essentially ranges from 1 g/l to 8 g/l, preferably from 2 g/l to 6 g/l. Said content is essentially equal to half of the total content of Polygonum Cuspidatum and Vitis vinifera extracts.

Medicago sativa extracts can be obtained by a process of drying and titration of the powders or by solvent extraction.

The beer may comprise cynarine and, preferably, Cynara scolymus extracts comprising cynarine.

The content of Cynara scolymus extracts is significantly lower than 5 g/l, more specifically lower than 4 g/l, and, preferably, essentially ranges from 1 g/l to 3 g/l.

Said content is essentially equal to one quarter of the total content of Polygonum Cuspidatum and Vitis vinifera extracts.

Cynara scolymus extracts can be obtained by a drying and titration process of the powders or by solvent extraction.

The invention comprises a new beer brewing process.

The beer brewing process involves the steps that generally characterise a beer-making process.

These phases may comprise, appropriately as according to the order described here, at least one maturation phase; and/or at least one piling step; and/or at least one filtration step; and/or at least one cooking step; and/or at least one fermentation step; and/or at least one pasteurisation step; and/or at least one additional filtration step.

In one or more phases prior to fermentation, a base fluid is obtained, usefully a base liquid, from which the beer is obtained.

Therefore, in the fermentation phase a base fluid, usefully a base liquid, is fermented creating the beer.

The fermentation phase may comprise at least one pre-fermentation phase of said base fluid; and/or at least one first fermentation phase (primary fermentation) of the base fluid; and/or at least one second fermentation phase (secondary fermentation) of the base fluid.

These steps and phases are known.

The beer brewing process is characterised in that it comprises a phase for adding one or more extracts to the beer and, in particular, to the base fluid.

Said addition phase can occur prior to the fermentation step, in particular to the second fermentation phase and, preferably, 5-10 hours before the second fermentation phase.

Polygonum Cuspidatum and/or Vitis vinifera extracts may be introduced during the addition phase in an appropriate manner and in accordance with the above content.

Beta vulgaris and/or Chenopodium quinoa extracts may be introduced during the addition phase.

Momordica cochinchinensis extracts may be introduced during the addition phase in an appropriate manner and in accordance with the above content.

Arachis hypogaea extracts may be introduced during the addition phase in an appropriate manner and in accordance with the above content.

Medicago sativa extracts may be introduced during the addition phase in an appropriate manner and in accordance with the above content.

Cynara scolymus extracts may be introduced during the addition phase in an appropriate manner and in accordance with the above content.

The beer brewing process may comprise a phase in which resveratrol is methylated; resveratrol is usefully contained in Polygonum Cuspidatum and/or Vitis vinifera extracts, inducing a greater formation of pterostilbene, which is usefully contained in Polygonum Cuspidatum and/or Vitis vinifera extracts.

Said methylation phase may occur prior, at the same time as, and/or after the fermentation phase.

The methylation phase for resveratrol (usefully present in at least the Polygonum Cuspidatum and/or Vitis vinifera extracts) occurs with at least the trimethylglycine (usefully present in at least the Beta vulgaris L. extracts), and the folic acid (usefully present in at least the Medicago sativa extracts) ensures that the folic acid makes at least part of the methyl groups present in the trimethylglycine, usefully all of them, available so that said resveratrol is methylated to produce pterostilbene.

It should be noted that with the process of methylation, i.e. with the methylation, the resveratrol is not transformed into pterostilbene, but rather the process of methylation, described here, results in a greater production of pterostilbene.

Therefore, expressions such as “resveratrol is methylated to produce pterostilbene” identify the production of pterostilbene owing to the presence of resveratrol according to the process described here.

The beer 1 according to the invention and in particular its consumption achieve important advantages in accordance with the above content.

In fact, Momordica cochinchinensis extracts are rich in lycopene, an active ingredient with strong antioxidant power and, therefore, able to block the action of free radicals that cause early cell aging and serious diseases such as cancer, cardiovascular disease, diabetes, multiple sclerosis, rheumatoid arthritis, pulmonary emphysema, cataracts, Parkinson's and Alzheimer's disease, and dermatitis.

Therefore, lycopene, being extremely effective in destroying free radicals in the human body, protects the cardiovascular system (e.g. atherosclerosis, hypertension, heart attack, stroke, by reducing the oxidation of LDL cholesterol) and acts on tumours (pancreas, digestive system, prostate, breast, liver, skin) and degenerative diseases of the central nervous system (Alzheimer's, Parkinson's), osteoporosis and some forms of diabetes (mellitus).

It should be emphasised that lycopene has double the antioxidant power of β-carotene and ten times that of vitamin E.

The action of lycopene and, therefore, of Momordica cochinchinensis extracts is synergistically supported by Arachis hypogaea extracts and, in particular, by coenzyme Q10.

Coenzyme Q10 is a powerful antioxidant that, in synergy with lycopene, protects the cardiovascular system and improves cellular energy production and the synthesis of adenosine triphosphate-ATP. Therefore, coenzyme Q10's role in the synthesis of ATP leads to an improvement, that is in synergy with lycopene, in congestive heart function and with mitochondrial dysfunction and insufficient cellular energy production.

It should be pointed out that the synergistic effect of lycopene and coenzyme Q10 is highlighted by the particular ratio of contents of Momordica cochinchinensis extracts and Arachis hypogaea extracts.

The action of lycopene and coenzyme Q10 is in turn reinforced by the presence of resveratrol.

Resveratrol is a component with a high antioxidant power and, therefore, protects against cardiovascular diseases, slowing down the evolution of cancers and limiting blood cholesterol. In particular, its anti-tumour action is owed to its ability to deactivate the NF-Kappa-B protein that protects cancer cells.

Resveratrol also acts strongly on the cardiovascular system. In fact, it has the properties of antioxidants, platelet aggregation inhibitors, cardiovascular dilators, with a consequent lowering of blood pressure, and LDL oxidation inhibitors and lipoproteins responsible for transporting cholesterol to the cells of the body.

Pterostilbene is chemically similar to resveratrol and, therefore, acts similarly to it, for example in terms of anti-inflammatory, antineoplastic, and antioxidant action.

These actions of resveratrol and/or pterostilbene define how the Polygonum Cuspidatum and Vitis vinifera extracts are synergistic with the Momordica cochinchinensis and Arachis hypogaea extracts. It should be noted that this synergistic action can be accentuated thanks to the particular content ratios of said extracts.

The cardiovascular effect of one or more of the above-mentioned extracts is accentuated by the medicago sativa extracts thanks, in particular, to their particular content in the beer.

In fact, these extracts have an anticholesterolemic effect thanks to their saponin content, which reduces cholesterol.

In addition, the cardiovascular action of the medicago sativa extracts is owed to the mild antithrombosis action, resulting from the coumarins contained in them, and to the content in folic acid that acts to limit homocysteine.

The above-described actions of one or more of the extracts are finally reinforced by the Cynara scolymus extracts. It should be noted that this synergistic action can be accentuated thanks to the particular content ratios of said extracts.

In fact, the Cynara scolymus extracts comprise a high content of cynarine, a powerful hypocholesterolemic effect.

The invention is susceptible of variations falling within the scope of the inventive concept as defined by the claims. In this context all the details may be replaced with equivalent elements and the materials, shapes, and dimensions may be as desired.

1. A beer comprising Momordica cochinchinensis extracts comprising lycopene and Arachis hypogaea extracts comprising coenzyme Q10.

2. The beer according to claim 1, comprising a content of said Momordica cochinchinensis extracts ranging from substantially 1 g/l to 7 g/l.

3. The beer according to claim 1, comprising a content of said Arachis hypogaea extracts ranging from substantially 1 g/l to 6 g/l.

4. The beer according to claim 1, comprising at least one of the following: Polygonum Cuspidatum extracts comprising resveratrol and pterostilbene, and Vitis vinifera extracts comprising resveratrol and pterostilbene.

5. The beer according to claim 1, comprising Beta vulgaris extracts comprising trimethylglycine.

6. The beer according to claim 4, comprising a total content of said Polygonum Cuspidatum extracts and said Vitis vinifera extracts ranging from substantially 13 g/l to 15 g/l.

7. The beer according to claim 1, comprising Arachis hypogaea extracts comprising folic acid.

8. The beer according to claim 7, comprising a content of said Medicago sativa extracts ranging from substantially 1 g/l to 8 g/l.

9. The beer according to claim 1, comprising Cynara scolymus extracts comprising cynarine.

10. The beer according to claim 1, comprising a content of said Cynara scolymus extracts which is less than 4 g/l.

11. A beer brewing process, comprising at least one fermentation phase of a base fluid and comprising an addition phase in which Momordica cochinchinensis extracts comprising lycopene and Arachis hypogaea extracts comprising coenzyme Q10 are added.

12. The beer brewing process according to claim 11, wherein Beta vulgaris extracts comprising trimethylglycine and at least one of the following: Polygonum Cuspidatum extracts comprising resveratrol and pterostilbene and Vitis vinifera extracts comprising resveratrol and pterostilbene are added during said addition phase.

13. The beer brewing process according to claim 12, comprising a methylation phase of said resveratrol, which is methylated to produce pterostilbene, wherein said folic acid makes at least part of the methyl groups present in said trimethylglycine available so that said resveratrol is methylated to produce pterostilbene.

14. A beer brewing process according to claim 11, wherein during said fermentation phase a base fluid is fermented producing said beer; and wherein said addition phase occurs prior to said fermentation phase and wherein during said addition phase said Momordica cochinchinensis and Arachis hypogaea extracts are added to said base fluid.
